(19) United States
(12) Patent Application Publication
(10) Pub. No.: US 2026/0224003 A1
(43) Pub. Date: Aug. 6, 2026

(54) FLEXIBLE FILAMENTOUS MATERIAL CLEANING DEVICE

(71) Applicant: Oufan Cleaning Technology (Ningbo) Co., Ltd., Ningbo City (CN)

(72) Inventors: Xiaxin Wu, Ningbo City (CN); Fangping Jiang, Ningbo City (CN)

(21) Appl. No.: 19/632,154

(22) Filed: Mar. 27, 2026

(30) Foreign Application Priority Data
Feb. 6, 2026 (CN) 202610175481.2

(51) Int. Cl. A45D 19/02

(52) U.S. Cl. CPC A45D 19/022

(57) ABSTRACT

A flexible filamentous material cleaning device includes a spray conduit, a water pump, a suction conduit, and a vacuum pump. Spray orifices are provided on the spray conduit, suction orifices are provided on the suction conduit in a corresponding manner, and a cross-sectional area of the spray orifice is smaller than a cross-sectional area of the suction orifice. Power of the water pump is smaller than power of the vacuum pump, such that a stable fluid column directed from the spray orifice to the suction orifice is formed between the spray orifice and the suction orifice. When no flexible filamentous material is present, the fluid column is completely sucked back; when the flexible filamentous material passes through, the scattered fluid is still capable of being efficiently sucked back to form a closed loop.

### TECHNICAL FIELD

The present invention relates to the technical field of cleaning flexible filamentous materials, and specifically relates to a flexible filamentous material cleaning device, which cleans a flexible filamentous material through an air-gap recirculation design.

### BACKGROUND

In daily life, efficient cleaning and fast drying of flexible filamentous materials such as natural hair, wigs, hairpieces, and pet hair are a universal demand. Currently, common cleaning methods mainly include manual water washing, traditional water flow flushing, and dry cleaning using devices such as handheld cleaners.

Manual water washing is usually performed in a sink or a basin, the process of which is cumbersome and involves high water consumption; furthermore, after cleaning, the flexible filamentous material such as hair is severely tangled and difficult to comb, and a drying time is extremely long. Although traditional water flow flushing devices can reduce the labor burden, most of the traditional water flow flushing devices focus on spray cleaning and lack an effective instant recovery mechanism, leading to splashing of waste water and serious waste of water resources, and the items remain wet after cleaning and still need to be aired for a long time.

Some improved cleaning devices attempt to introduce a water suction function. For example, some devices employ a technology of synchronized spraying and suction, which is currently widely applied in the soft furnishing cleaning industry to perform integrated spray-and-suction cleaning on objects such as carpets, sofas, and curtains. This technology involves spraying toward a cleaning object and then sucking back in an opposite direction; the spraying has a certain width, and the water flow that is not sprayed onto the cleaning object cannot be sucked back and is sprayed to the outside, which means there is no technical feature of air-gap recirculation. If used for cleaning flexible filamentous materials such as hair, the spraying penetrates the filamentous material and is sprayed to a distance, making it impossible to suck back; moreover, the impact force of the spraying disturbs the filamentous material, preventing effective cleaning, which not only wastes water resources but also produces secondary pollution to the environment.

There are also other technologies such as ultrasonic cleaning; although having a certain cleaning effect, the other technologies have limited cleaning power for firmly attached stains, and have high equipment costs and high energy consumption, making it difficult to popularize the other technologies in household scenarios.

In summary, the prior art lacks a specialized flexible filamentous material cleaning device integrating efficient flushing, water saving, and fast drying. Therefore, there is an urgent need in the field for an innovative technical solution capable of achieving gentle, thorough, and convenient cleaning of hair-type articles under the premise of low water consumption and low energy consumption.

To solve the above technical problems, the present invention is solved by the following technical solution.

A flexible filamentous material cleaning device includes a spray conduit, a water pump, a suction conduit, and a vacuum pump. At least one spray orifice is provided on the spray conduit, wherein the spray orifice is configured for spraying a liquid for cleaning. The water pump is connected to the spray conduit and is configured for supplying water to the spray conduit. Suction orifices are provided on the suction conduit in a quantity corresponding to a quantity of the spray orifices, wherein the suction orifices are configured for sucking back the fluid. Some application scenarios require additional suction orifices provided in other directions to absorb scattered liquid. The vacuum pump is connected to the suction conduit and is configured for evacuating the suction conduit. Wherein, a cross-sectional area of the spray orifice is smaller than a cross-sectional area of the suction orifice. The spray orifice and the suction orifice are disposed opposite to each other in one-to-one correspondence and have a certain spacing therebetween to form a cleaning space; power of the water pump is smaller than power of the vacuum pump, such that the fluid sprayed from the spray orifice is capable of being sucked back by the corresponding suction orifice to form an air-gap recirculation.

Through this design, when no flexible filamentous material is present, a fluid column directed from the spray orifice to the suction orifice is formed between the spray orifice and the suction orifice to achieve air-gap recirculation; when the flexible filamentous material passes through the fluid column, the small spacing between the spray orifice and the suction orifice is used for limiting a quantity of passing flexible filamentous materials and for ensuring that suction force is not excessively attenuated, such that the scattered fluid is capable of being sucked back by the suction orifice.

As a preferred embodiment of the flexible filamentous material cleaning device, a plurality of spray branch conduits is provided on the spray conduit, wherein the spray orifices are located on the spray branch conduits; a plurality of suction branch conduits are provided on the suction conduit, wherein the suction orifices are located on the suction branch conduits; the spray branch conduits and the suction branch conduits are distributed alternately, and a cleaning space is formed between the spray orifices and the suction orifices on adjacent spray branch conduits and suction branch conduits. By providing the spray branch conduits and the suction branch conduits distributed alternately, a cleaning area having a plurality of parallel cleaning units is formed. This significantly increases an effective area of a single cleaning operation and is capable of simultaneously processing a larger amount of the flexible filamentous material, thereby significantly improving the cleaning efficiency and throughput of the entire device.

As a preferred embodiment of the flexible filamentous material cleaning device, the spray orifice and the suction orifice are disposed directly opposite or have an inclined angle. The arrangement disposed directly opposite can form a most direct fluid column with minimum energy loss; while the adopting an inclined angle can adapt to different internal structural layouts, or generate a shear fluid having a combing effect on the flexible filamentous material to enhance the cleaning effect.

As a preferred embodiment of the flexible filamentous material cleaning device, a spacing L between the spray orifice and the suction orifice is 1 mm to 10 mm. By limiting the spacing between the spray orifice and the suction orifice to a range of 1 to 10 millimeters, stable formation and efficient recovery of the fluid column are ensured. An excessively large spacing will lead to fracture of the fluid column and attenuation of the suction force; an excessively small spacing is not conducive to the passage of the flexible filamentous material and may affect fluid dynamics. This preferred range achieves stability and high efficiency of a fluid closed loop while ensuring that the cleaning space is sufficient.

As a preferred embodiment of the flexible filamentous material cleaning device, the cross-sectional area of the spray orifice is 0.075 mm² to 3 mm², and the cross-sectional area of the suction orifice is 1 mm² to 12 mm². The spray orifice with a small cross-sectional area helps to form a fluid jet with strong convergence and moderate impact force, while the suction orifice with a large cross-sectional area provides a wide capture range and a large flow capacity. This structure design of "small-spray and large-suction" ensures that even if the flexible filamentous material passes through and scatters a part of the water flow, the scattered fluid can still be effectively captured and sucked back, thereby maintaining dryness of a work area.

As a preferred embodiment of the flexible filamentous material cleaning device, the power of the water pump is 3 W to 30 W. Limiting the power of the water pump to a low power range of 3 to 30 W enables saving of energy under the premise of ensuring the formation of a stable cleaning water flow, which conforms to a development trend of product miniaturization and energy saving.

As a preferred embodiment of the flexible filamentous material cleaning device, the power of the vacuum pump is 300 W to 3000 W. Setting the power of the vacuum pump to a relatively high range of 300 to 3000 W can provide a strong negative pressure suction force sufficient to ensure that the scattered water flow can be rapidly and thoroughly sucked back, thereby forming an efficient fluid closed loop.

As a preferred embodiment of the flexible filamentous material cleaning device, the device further includes an air pump, wherein the air pump is connected to the spray conduit. The air pump, as an optional component, expands the functions of the device, enabling the device to not only perform liquid cleaning but also switch to an air blowing mode. By spraying an airflow to blow up residual liquid which is then strongly sucked away by the opposite suction orifice, this fast-drying method interleaved among flexible filamentous materials such as hair provides functions and user experience that current conventional electric hair dryers do not possess. This is because existing hair dryer technology involves blowing air from the outside and lacks a suction function; consequently, when the flexible filamentous material such as hair is dense, drying with the electric hair dryer requires moving the hair to assist, and sometimes requires adding an extra covering to avoid peripheral objects such as clothing from being splashed by the blown-out residual liquid. In contrast, this preferred embodiment provides a method of passing through the interior of the flexible filamentous material such as hair and sucking back the blown-up residual liquid by the opposite suction orifice, which improves drying efficiency, brings an efficient room-temperature air-drying function, and can avoid damage to the flexible filamentous material, such as hair, caused by frequent high-temperature air-drying. By reducing an electric heating module, the room-temperature air-drying function significantly reduces energy consumption. The versatility of the device and the user experience are further improved.

As a preferred embodiment of the flexible filamentous material cleaning device, power of the air pump is 5 W to 50 W. Limiting the power of the air pump to a power range of 5 to 50 W can ensure that the airflow has sufficient impact force for cleaning or drying, while also controlling energy consumption and noise, achieving a balance between performance and energy efficiency.

As a preferred embodiment of the flexible filamentous material cleaning device, the device further includes a cleaning agent supply device configured for injecting a cleaning agent into the spray conduit. A user does not need to manually pre-mix a cleaning liquid, which simplifies an operation process and can ensure that the cleaning agent is uniformly mixed with the water flow, thereby significantly improving a cleaning effect and cleaning efficiency for stubborn stains.

Compared with the prior art, the present application has the following advantageous technical effects: efficient cleaning of the flexible filamentous material is achieved by providing the spray orifice and the suction orifice at opposite positions at a close distance. At the same time, since most of the fluid is sucked back instantly, liquid residue is reduced, enabling the cleaned items to dry quickly without subsequent air-drying, which improves efficiency and also saves water resources.

### BRIEF DESCRIPTION OF THE DRAWINGS

FIG. 1 is a schematic structural view of a flexible filamentous material cleaning device.

FIG. 2 is a partially enlarged view of part A in FIG. 1.

FIG. 3 is a schematic structural view of another embodiment.

FIG. 4 is a schematic structural view of yet another embodiment.

The description of the reference numerals is as follows: 10. spray conduit; 11. spray orifice; 12. spray branch conduit; 13. heating unit; 20. water pump; 30. suction conduit; 31. suction orifice; 32. suction branch conduit; 40. vacuum pump; 50. air pump; 60. cleaning agent supply device.

### DETAILED DESCRIPTION OF THE DISCLOSURE

The present invention will be further described in detail below in conjunction with the accompanying drawings and specific embodiments.

In the following embodiments, the same or similar reference numerals represent the same or similar elements or elements with the same or similar functions throughout. The embodiments described below by referring to the accompanying drawings are exemplary and are only used to explain the present invention, and cannot be understood as limiting the present invention.

In the description of the present invention, it should be understood that terms such as: center, longitudinal, transverse, length, width, thickness, upper, lower, front, rear, left, right, vertical, horizontal, top, bottom, inner, outer, clockwise, and counterclockwise indicate orientation or positional relationships based on the orientation or positional relationships shown in the accompanying drawings, which are only for convenience of describing the present invention and simplifying the description, and therefore cannot be understood as limiting the present invention. In addition, terms such as: first and second are only used for descriptive purposes and cannot be understood as indicating or implying relative importance or implicitly specifying the quantity of indicated technical features. In the description of the present invention, unless otherwise clearly specified and defined, terms such as: installed, linked, and connected should be understood in a broad sense, and those skilled in the art can understand specific meanings of the above terms in the present application according to specific situations.

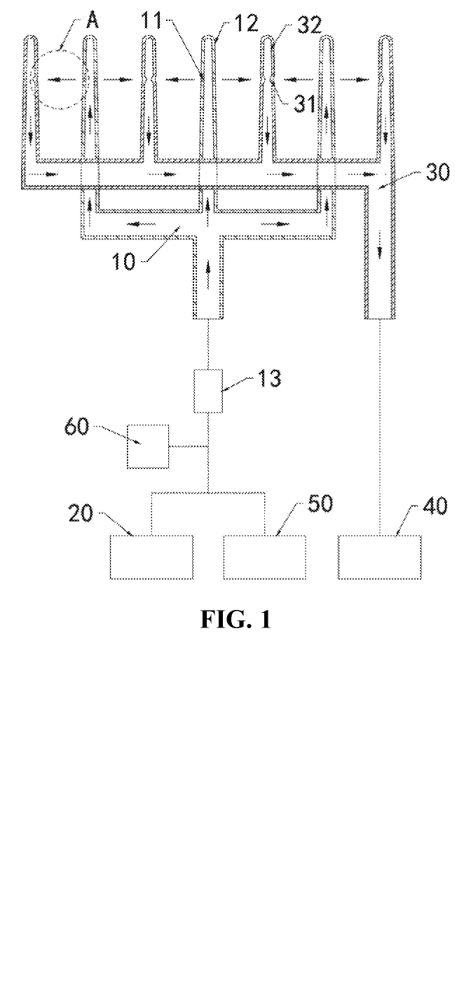

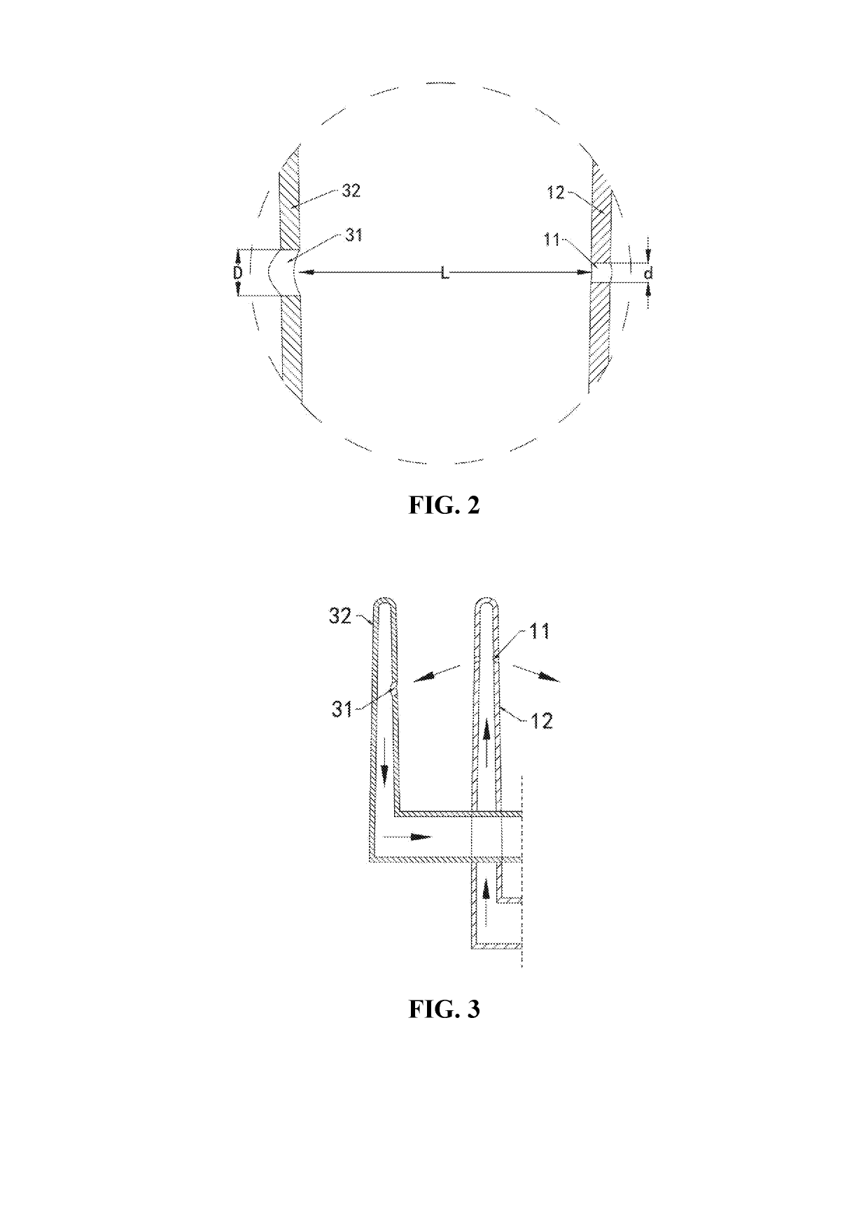

Referring to FIG. 1 and FIG. 2, the present invention provides an efficient and energy-saving flexible filamentous material cleaning device, which achieves integrated functions of cleaning flexible filamentous material, fluid recovery, and fast drying through collaborative design of a spray system and a suction system.

The flexible filamentous material cleaning device includes a spray conduit 10, a water pump 20, a suction conduit 30, and a vacuum pump 40. At least one spray orifice 11 is provided on the spray conduit 10 for spraying a fluid for cleaning, and the fluid can be clean water, an airflow, or a mixed liquid containing a cleaning agent. The water pump 20 is linked to the spray conduit 10 to provide a required fluid for the spray conduit 10. Suction orifices 31 are provided on the suction conduit 30 in a quantity corresponding to a quantity of the spray orifices 11 for recovering the fluid sprayed from the spray orifices 11. The vacuum pump 40 is connected to the suction conduit 30 to form a negative pressure zone at the suction orifices 31 by evacuating the suction conduit 30.

Wherein, shapes of the spray orifice 11 and the suction orifice 31 are not limited, and sizes of the spray orifice 11 and the suction orifice 31 are defined by a flow cross-sectional area (for example, can be circular, elliptical, square, triangular, etc.). The spray orifice 11 and the suction orifice 31 are disposed opposite to each other in one-to-one correspondence, and a specific spacing is provided between the spray orifice 11 and the suction orifice 31 to jointly constitute a cleaning area through which the flexible filamentous material passes. A cross-sectional area of the spray orifice 11 is preferably 0.075 mm² to 3 mm², and a cross-sectional area of the suction orifice 31 is preferably 1 mm² to 12 mm². This cross-sectional area configuration of "small-spray and large-suction" ensures that when the flexible filamentous material disturbs a fluid column, the scattered fluid can still be efficiently sucked back, maintaining a work area clean and dry. As a preferred specific embodiment, both the spray orifice 11 and the suction orifice 31 are circular holes, and a spacing L between the spray orifice 11 and the suction orifice 31 is set to 1 mm to 10 mm. This range can ensure stable morphology of the fluid column and effective action of suction force, and also provides sufficient space for the passage of the flexible filamentous material, taking into account both a cleaning effect and fluid recovery efficiency. A diameter d of the spray orifice 11 is preferably 0.1 mm to 0.8 mm to form a fluid jet with strong convergence and moderate impact force; a diameter D of the suction orifice 31 is preferably 1 mm to 10 mm to provide a sufficient fluid capture area and flow capacity.

Power of the water pump 20 is smaller than power of the vacuum pump 40, thereby forming a stable fluid path directed from the spray orifice 11 to the suction orifice 31 between the spray orifice 11 and the suction orifice 31. When no flexible filamentous material passes through, the fluid sprayed from the spray orifice 11 can be completely sucked back by the corresponding suction orifice 31 in a form of a smooth water column; when the flexible filamentous material passes through the fluid path, although part of the fluid is blocked or scattered, the fluid can still be effectively captured and recovered under action of a large aperture and strong suction force of the suction orifice 31, forming a closed-loop flow. This design achieves continuous and efficient cleaning of the flexible filamentous material by means of spraying water from the spray orifice 11 and sucking water into the suction orifice 31, and significantly reduces fluid residue during the cleaning process, improves a drying speed, and reduces water resource consumption, which conforms to a green design concept.

In a preferred embodiment, a plurality of spray branch conduits 12 are provided on the spray conduit 10, and the spray orifice 11 is provided at an end of the branch conduit; the suction conduit 30 is correspondingly provided with a plurality of suction branch conduits 32, and the suction orifice 31 is provided at an end of the branch conduit. The spray branch conduits 12 and the suction branch conduits 32 are distributed alternately, and independent cleaning units are formed between adjacent spray branch conduits 12 and suction branch conduits 32. This parallel layout structure effectively expands a cleaning area and is suitable for batch processing of the flexible filamentous material, significantly improving overall cleaning efficiency; and the spray branch conduits 12 cooperate with the suction branch conduits 32 to form a combing structure, which can comb the flexible filamentous material while cleaning. To further optimize fluid dynamics performance, the spray orifice 11 and the suction orifice 31 can be disposed directly opposite to form an ideal fluid column with minimum energy loss.

In another preferred embodiment, referring to FIG. 3, the spray orifice 11 on the spray branch conduit 12 and the suction orifice 31 on the suction branch conduit 32 are disposed opposite to each other at a certain inclined angle, and an axis of the spray orifice 11 or the suction orifice 31 has an included angle with a horizontal plane. When hair passes through the inclined fluid column formed thereby, this design can generate stronger turbulence and shear force inside and around the fluid column, thereby more effectively flushing and stripping dirt and dander attached deep in the hair, and enhancing a cleaning effect on the flexible filamentous material.

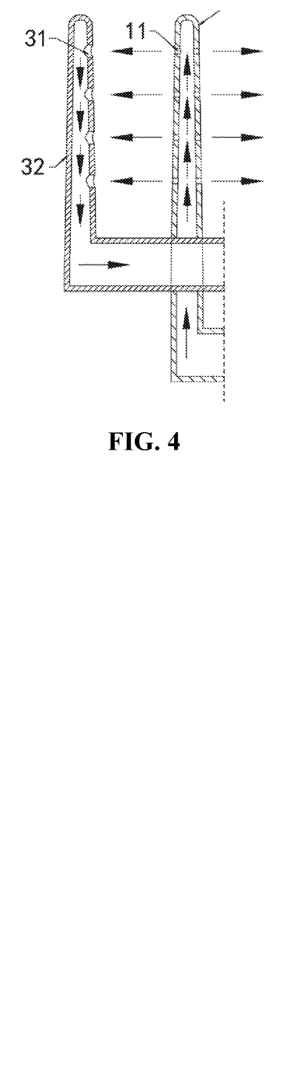

In yet another preferred embodiment, referring to FIG. 4, on a single spray branch conduit 12, a plurality of spray orifices 11 are linearly arranged along a longitudinal direction of the single spray branch conduit 12; correspondingly, on a single suction branch conduit 32 parallel to the single spray branch conduit 12, a plurality of suction orifices 31 corresponding in quantity and position are also linearly arranged. Each pair of the spray orifice 11 and the suction orifice 31 constitutes an independent cleaning unit, and an entire row of cleaning units jointly form a continuous strip-shaped cleaning area. This structure is particularly suitable for cleaning strip-shaped or large sheet-like hair products, such as a hair weft or a hair piece. A user only needs to pull the hair product through the cleaning area at a constant speed to complete uniform cleaning of an entire width at one time, which greatly improves cleaning efficiency and uniformity, and avoids local omission or repeated cleaning.

In terms of power configuration, the power of the water pump 20 is preferably 3 W to 30 W, which can realize low energy consumption operation while ensuring formation of a stable cleaning jet. The power of the vacuum pump 40 is preferably 300 W to 3000 W to provide sufficient negative pressure suction force and ensure timeliness and integrity of a fluid recovery process.

To further expand functions of the device, an air pump 50 can further be provided, an outlet of which is connected to the spray conduit 10. By switching a work mode, the device can not only perform liquid cleaning but can also be converted to air blowing or air-drying, improving versatility of the device and user experience. Power of the air pump 50 is preferably 5 W to 50 W, taking into account both airflow intensity and energy efficiency control. The device can also integrate a cleaning agent supply device 60 for automatically injecting a cleaning agent into the spray conduit 10 according to a set ratio. This design saves steps of manual preparation by the user, ensures that the cleaning agent is uniformly mixed, and effectively improves cleaning efficiency for stains.

In addition, the device can also include a heating unit 13 provided in the spray conduit 10 for appropriately heating a fluid or an airflow. Temperature-controlled cleaning further improves a cleaning effect and user experience, and is especially suitable for low-temperature environments or scenarios requiring thermal-assisted decontamination.

The scope of protection of the present invention includes but is not limited to the above embodiments. The scope of protection of the present invention is subject to the claims. Any replacement, deformation, or improvement made to the technology that is easily thought of by those skilled in the art shall fall within the scope of protection of the present invention.

What is claimed is:

1. A flexible filamentous material cleaning device, comprising:
a spray conduit provided with at least one spray orifice, wherein the spray orifice is configured for spraying a fluid for cleaning;
a water pump connected to the spray conduit and configured for supplying water to the spray conduit;
a suction conduit provided with suction orifices in a quantity corresponding to a quantity of the spray orifices, wherein the suction orifices are configured for sucking back the fluid;
a vacuum pump connected to the suction conduit and configured for evacuating the suction conduit;
wherein a cross-sectional area of the spray orifice is smaller than a cross-sectional area of the suction orifice; the spray orifice and the suction orifice are disposed opposite to each other in one-to-one correspondence and have a spacing therebetween to form a cleaning space; and power of the water pump is smaller than power of the vacuum pump, such that the fluid sprayed from the spray orifice is capable of being sucked back by the corresponding suction orifice.

2. The flexible filamentous material cleaning device according to claim 1, wherein the spray conduit is provided with a plurality of spray branch conduits, the spray orifices are located on the spray branch conduits, the suction conduit is provided with a plurality of suction branch conduits, and the suction orifices are located on the suction branch conduits ; the spray branch conduits and the suction branch conduits are distributed alternately, and a cleaning space for cleaning the flexible filamentous material is formed between the spray orifices and the suction orifices on adjacent spray branch conduits and suction branch conduits.

3. The flexible filamentous material cleaning device according to claim 1, wherein the spray orifice and the suction orifice are disposed directly opposite or have an inclined angle.

4. The flexible filamentous material cleaning device according to claim 1, wherein a distance L between the spray orifice and the suction orifice is 1 mm to 10 mm.

5. The flexible filamentous material cleaning device according to claim 1, wherein the cross-sectional area of the spray orifice is 0.075 mm² to 3 mm², and the cross-sectional area of the suction orifice is 1 mm² to 12 mm².

6. The flexible filamentous material cleaning device according to claim 1, wherein the power of the water pump is 3 W to 30 W.

7. The flexible filamentous material cleaning device according to claim 1, wherein the power of the vacuum pump is 300 W to 3000 W.

8. The flexible filamentous material cleaning device according to claim 1, further comprising an air pump, wherein the air pump is connected to the spray conduit.

9. The flexible filamentous material cleaning device according to claim 8, wherein power of the air pump is 5 W to 50 W.

10. The flexible filamentous material cleaning device according to claim 1, further comprising a cleaning agent supply device configured for injecting a cleaning agent into the spray conduit.
